(19) United States
(12) Patent Application Publication
(10) Pub. No.: US 2010/0088923 A1
(43) Pub. Date: Apr. 15, 2010

(54) MEAL DRYER/COOLER

(75) Inventor: Federico Lopez, Madrid (ES)

Correspondence Address: WEGMAN, HESSLER & VANDERBURG, 6055 ROCKSIDE WOODS BOULEVARD, SUITE 200, CLEVELAND, OH, 44131, US

(73) Assignee: DESMET BALLESTRA NORTH AMERICA, INC., Marietta, GA (US)

(21) Appl. No.: 12/449,703

(22) PCT Filed: Feb. 28, 2008
(86) PCT No.: PCT/US2008/002670

§ 371 Date: Aug. 21, 2009

Related U.S. Application Data
(60) Provisional application No. 60/906,980, filed on Mar. 14, 2007.
(60) Provisional application No. 60/933,354, filed on Jun. 6, 2007.

(51) Int. Cl. F26B 7/00; F26B 19/00

(52) U.S. Cl. 34/380; 34/65

(57) ABSTRACT

Dryer/cooler (2) for oil bearing vegetable matter meal is provided wherein the dryer/cooler (2) has a cooling zone (22) and a drying zone (24) separated by a double bottom air plenum (28). The first surface (100) of the air plenum comprises a plurality of countersink bores (102) each receiving a slotted disc member (104) therein to provide open communication between the air plenum (26, 28) and one of the cooling or drying zones (22, 24).

### CROSS REFERENCE TO RELATED APPLICATIONS

This application claims the priority benefit of U.S. Provisional Patent Application Ser. No. 60/906,980 filed Mar. 14, 2007 and of U.S. Provisional Patent Application Ser. No. 60/933,354 filed Jun. 6, 2007.

### FIELD OF THE INVENTION

The invention pertains to an improved meal dryer/cooler.

### BACKGROUND OF THE INVENTION

Oleagineous materials such as soybeans, rapeseed, sunflower seed, cottonseed, corn germ, etc. are prepared by thermal and mechanical means and then introduced into a solvent extractor wherein they are washed with hexane-based solvents to separate the liquid oil fraction from the solid meal fraction. The solid meal fraction discharges the extractor apparatus with approximately thirty percent by weight of residual solvent. The solid meal fraction is then introduced into a meal desolventizer toaster for the purpose of using steam, applied both indirectly and directly to the meal, to thermally remove the solvent. In the process of desolventizing the solid meal fraction, the temperature typically increases to 108° C. and the moisture increases to 18-20 percent by weight.

After the solvent-laden material is desolventized, it is conveyed to the meal dryer cooler, commonly referred to as the DC. The primary purposes of the DC are to reduce the moisture in the meal to within trading rule limits, and to lower the meal temperature prior to storage. DCs are vertical, cylindrical vessels with a multitude of horizontal trays. The desolventized material enters at the top and is supported by the tray. The material is mixed above each tray, and conveyed downward from tray to tray by agitating sweeps anchored to a central rotating shaft. The DC has two different types of trays; air drying trays, and air cooling trays.

The air drying trays of the DC are designed with an upper plate, lower plate, and structural members between designed to hold low pressure air. The air drying trays are designed with a plurality of small round apertures, approximately 3 to 4 mm diameter, across their entire upper surface to evenly introduce air into the meal. The quantity of apertures is calculated to provide sufficient back pressure to prevent meal from sifting into the air tray. The combined area of the many small apertures represents approximately 0.8% of the tray surface. The air supplied to each air dryer tray is first filtered to remove dust, and then pressurized using a spark-proof centrifugal blower. The air for the dryer trays is passed through a steam-heated coil between the blower and the entrance to the dryer trays. After the air enters the trays, it flows upward through the meal at a nominal velocity of 14 to 21 m/min., partially fluidizing the meal. The meal evaporatively cools and the released moisture is transferred to the ascending air. The warm, damp air exits the top of the meal layer and then exits the sidewall of the DC to a cyclone collector to remove dust prior to discharge to atmosphere. The major source of heat for evaporating the moisture in the meal is the high temperature of the meal exiting the meal desolventizer toaster. When the meal drops in temperature from 108 to 38° C., the heat provided is adequate to reduce the meal moisture by 6.5%. For soybean meal, the trading rule moisture limit is 12.5%; therefore, if the incoming moisture from the DT does not exceed 19.0%, the DC will typically require no additional evaporative heat source to dry the meal. If additional heat is required for evaporating moisture from the meal, the air entering the meal dryer trays can be heated to temperatures up to 150° C. prior to entering the air drying trays. The heat source can be recovered flash steam, hot glycol-water solution, or fresh steam. The air must have adequate capacity to carry out the moisture released from the meal without becoming saturated. Cold air can hold less moisture than warm air, so winter conditions may limit the moisture-carrying capacity of the air. If additional heat is required for increasing the dew point of the incoming air, the air entering the air dryer trays can be heated to temperatures up to 150° C. The energy required to heat the incoming drying air is largely dictated by the incoming meal moisture to the DC.

The air cooling trays of the DC are designed with an upper plate, lower plate, and structural members between designed to hold low pressure air. The air cooling trays are designed with a plurality of small round apertures, approximately 3 to 4 mm diameter, across their entire upper surface to evenly introduce air into the meal. The quantity of apertures is calculated to provide sufficient back pressure to prevent meal from sifting into the air tray. The combined area of the many small apertures represents approximately 0.8% of the tray surface. The air supplied to each air cooler tray is first filtered to remove dust, and then pressurized using a spark-proof centrifugal blower. After the cool air enters the trays, it flows upward through the meal at a nominal velocity of 14 to 21 m/min., partially fluidizing the meal. The meal continues to evaporatively cool and also convectively cools. The cool, damp air exits the top of the meal layer and then exits the sidewall of the DC to a cyclone collector to remove dust prior to discharge to atmosphere. Ambient air is heated approximately 5° C. in temperature by the energy of the blower, before it blows into the air cooler trays of the DC. The meal cools down to within approximately 5° C. of the air temperature passing through the meal. Therefore, the temperature of the meal exiting the DC is typically cooled down to within 10° C. of ambient air. The dry cool meal is conveyed from the DC to outside the solvent extraction plant for size reduction and then on to meal storage. It is important to properly dry and cool the meal to prevent continued evaporative cooling in storage or transport, which will cause reduced flow-ability, solidification and bridging of the meal inside storage and transport vessels.

### SUMMARY OF THE INVENTION

Since the DC utilizes the heat of the meal as its major source of energy for reducing the meal moisture, it uses a minimum of steam and therefore has been seen as very thermally efficient. On the contrary, the fans required to push the air through the DC require a high electrical power demand. The basis of this invention was to modify the traditional DC in such a way as to maintain the thermal efficiency while simultaneously reducing the electrical power consumption of the fans.

The volumetric flow of air through the meal inside the DC must be maintained to insure adequate meal drying and cooling. Therefore, the key to reducing the fan electrical energy is through reducing the collective pressure drop to push the required volume of air through the incoming ductwork, DC air trays, the meal supported above the DC air trays, the outgoing ductwork and the cyclonic dust collectors. In studying the cumulative pressure drop through the entire air flow path, it was observed that approximately fifty percent of the entire pressure drop through the air path was caused by the air passing through the plurality of small round apertures at the top surface of each air tray. Attempts were first made to increase the quantity of small round apertures to reduce the back pressure. While this was effective in reducing pressure drop, the reduced pressure inside the air trays allowed meal supported above to sift through the round apertures and into the air trays. Meal inside the air trays becomes extremely dry and represents a smoldering hazard. Therefore, a different more novel approach was discovered for reducing pressure drop through the air trays.

It was found through experimentation that slotted apertures could replace round apertures in the top surface of the air trays. If the slotted apertures are approximately 0.25 mm in width, they have a sufficiently small enough width to allow the meal above to mechanically bridge the gap without sifting into the air tray. With this discovery, it was found that the total open area for air to pass through the air tray upper surface could be increased from approximately 0.8% up to approximately 2.0% without meal sifting into the tray. When the open area was nearly doubled, the pressure drop to push the air through the air tray was reduced by approximately half, and the total energy of the fan for the DC was reduced by approximately 25%.

The invention will be further described in the following detailed description that should be read in conjunction with the appended drawings.

### BRIEF DESCRIPTION OF THE DRAWINGS

FIG. 1 is a partially cutaway perspective view of a meal dryer/cooler (DC) in accordance with the invention comprised of one air drying tray and one air cooling tray;

FIG. 2 is a perspective view of one of the double walled air plenums that are used to distribute drying and/or cooling air flow to the meal in accordance with the invention;

FIG. 3 is a simplified cross-sectional schematic view of the air plenum shown in FIG. 2; and

FIG. 4 is a plan view of one of the slotted discs that are to be disposed along the air plenum surface in contact with the treated meal.

### DETAILED DESCRIPTION OF EXEMPLARY EMBODIMENTS

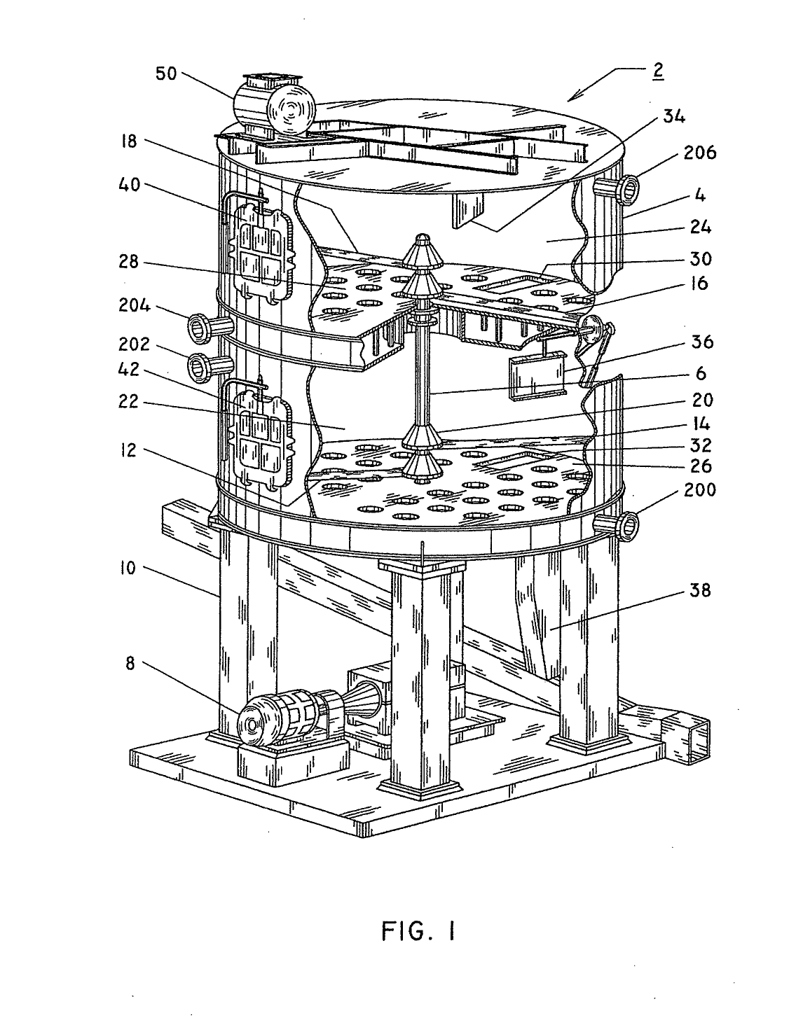

Turning first to FIG. 1, there is shown a meal dryer/cooler 2 in accordance with the invention. The meal dryer/cooler comprises a generally cylindrical housing 4 with a vertical shaft 6 extending through most of the housing and being generally coaxial therewith. The shaft is rotated by means of a motor 8 coupled thereto via conventional speed reducers, couplings and bearing members.

The assembly is supported by a plurality of supports 10. The vertical shaft 6 comprises a plurality of hub members 20 that carry radially extending stirrer arms 12, 14, 16, 18 which aid in stirring and moving the meal around the surface of the trays. As shown, a cooling zone or chamber 22 is provided between the trays 26 and 28 with a drying chamber 24 being defined between the tray 28 and the top portion of housing 4. Discharge gates 30, 32 are provided through the trays and feed the meal material via gravity discharge therethrough from the drying chamber 24 into the cooling chamber 22. After appropriate cooling, the meal is discharged through discharge gate 32 at the downstream or exit end of the apparatus with the meal then falling thru exit 38 for subsequent collection or further processing.

Doors 40 and 42 are provided in the respective cooling and drying chambers so as to provide for maintenance access. A fan 50 or the like is provided in communication with the cooling chamber 22 so as to push air and moisture through the apparatus.

As shown, a cool air entry line 200 is provided to admit cooling air into the plenum defined by the double bottom tray 26 with moist air exiting from the cooling chamber 22 at moist air exit 202. In similar fashion, dry air entry line 204 is provided to admit drying air into the double bottom tray 28 with very moist air exiting the drying chamber at exit 206.

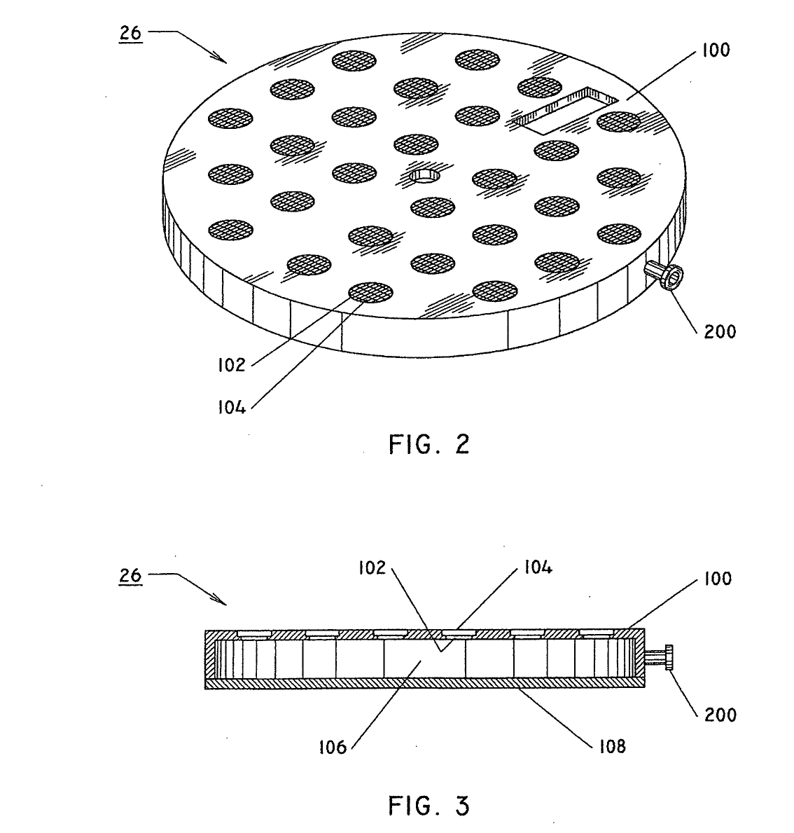

Turning now to FIG. 2, there is shown a perspective view of one of the double bottom trays utilized in accordance with the invention. Here, double bottom tray 26 is shown having a top surface 100 that is provided with a multiplicity of drilled circular countersink bores or the like 102 therein. Into each of the bores 102, a perforated disc 104, as shall be explained in more detail hereafter, is provided.

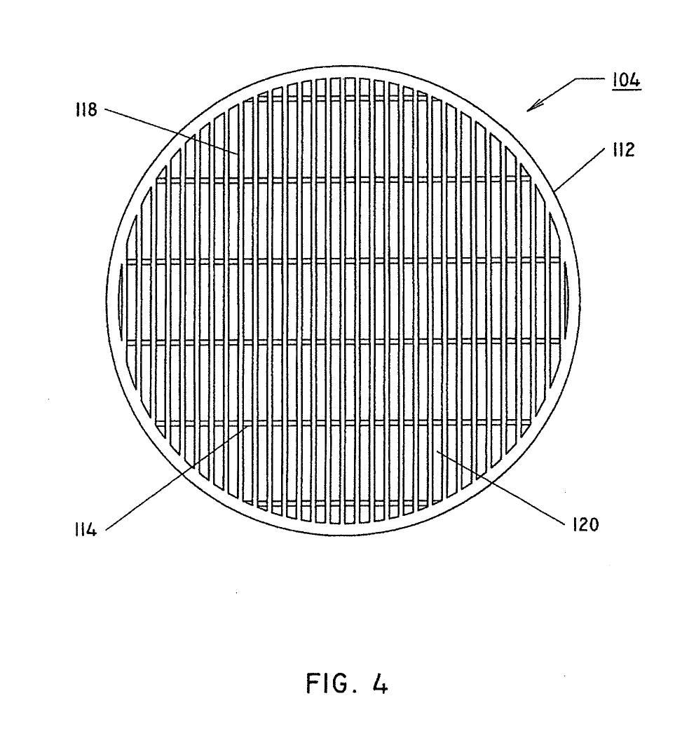

Turning to FIG. 3, it can be seen that the double bottom tray 26 comprises a solid bottom wall 108 that in combination with the solid upper surface 100 defines plenum 106. Cool air is admitted into this double bottom tray as shown at 200 and via fan or other action, is forced upwardly through the bores 102 and associated disc members 104. The tray 28 has similar construction two walled construction with a solid bottom surface and a top surface that, similar to tray 26, is provided with a substantially open structure due to the arrangement of the discs 104 therein.

The individual discs 104 are shown in more detail in FIG. 4. Here, it can be seen that each disc comprises an annulus 112 to which a plurality of bar members 104 are fixedly secured via welding or the like. Slots 120 are provided by the space between parallel bar members 118.

It is apparent then that the meal dryer/cooler apparatus of the invention includes a drying zone and cooling zone that are separated by a tray wherein the tray comprises an air plenum having a first surface and an opposing second surface. In accordance with one exemplary embodiment of the invention, the first surface comprises a plurality of bores therethrough with a disc member received in each of the bores. The disc member comprises a plurality of slots therein that allow air in the plenum to communicate with one of the drying and/or cooling zones. The opposing second surface of the air plenum as can be best seen in FIG. 3 is solid.

In a preferred embodiment of the invention, the first surface of the double walled or double bottom air plenum comprises an open area of greater than about 0.8% of the total first surface area.

Each disc comprises an annulus and rods and wires connected to each other and to the annulus to define slots. In one embodiment, the slots or interstices have a longitudinal dimension of about 75 mm to 300 mm and a width wise dimension or space of about 0.25 mm. The longitudinal dimension is not critical to performance in any way.

With further reference to FIG. 1 of the drawings, a first and second double bottom tray are provided with the first tray separating the cooling zone from the drying zone and with the second tray located at the exit end of the apparatus, at the bottom of the cooling zone. Each of these trays comprises a top surface thereof having a multiplicity of bores drilled therein with each of the bores receiving a disc as shown in FIG. 4 so as to ensure that cooling air and/or warming air will be able to circulate through the respective air plenum into the chamber in contact with the open surface. Air entry means are provided in each of the air plenums and, as per convention, air may be circulated in each via the use of fans or the like.

Preliminary results have demonstrated improved pressure drop characteristics such that pressure drop through the air dry and meal supported above is between about 200-300 mm of water in accordance with the invention. Further, total pressure drop of the fan is about 550-625 mm of water.

It is to be understood that the invention pertains to an improved meal dryer/cooler (DC) of the type that can be provided as a stand alone DC or as a part of a unit integral with a desolventizer or DT such as that shown in U.S. Pat. No. 4,622,760.

Preferably, the total open area of the surfaces of the trays should be between about 1.6-2.4% and the widths of the slots should preferably be on the order of about 0.2-1.0 mm.

While the form of apparatus herein described constitutes a preferred embodiment of this invention, it is to be understood that the invention is not limited to this precise form of apparatus and that changes may be made therein without departing from the scope of the invention which is defined in the appended claims.

What is claimed is:

1. In a meal dryer/cooler apparatus of the type in which a drying zone and cooling zone are provided that are separated by a tray, the improvement wherein said tray comprises an air plenum having a first surface and an opposing second surface, said first surface comprising a plurality of bores therethrough, a disc member received in each bore, said disc member comprising a plurality of slots therein thereby allowing air in said plenum to communicate with one of said zones.

2. Apparatus as recited in claim 1 wherein said second surface is solid.

3. Apparatus as recited in claim 2 wherein said first surface comprises an open area of greater than 0.8% of the total area of said first surface.

4. Apparatus as recited in claim 1 wherein each said disc comprises an annulus and rods and wires connected to each other and to said annulus to define said slots.

5. Apparatus as recited in claim 4 wherein said slots have a widthwise opening of about 0.25 mm.

6. Apparatus as recited in claim 3 wherein said first surface has an open area of between about 1.6% to about 2.4%.

7. A meal dryer/cooler apparatus of the type having a drying zone and a cooling zone, first and second double bottom trays with said first tray disposed adjacent said cooling zone and said second tray separating said drying zone from said cooling zone, said first tray having a first surface contiguous to said cooling zone and an opposing solid second surface thereby defining a first plenum chamber, a plurality of bores formed in said first surface, disc members disposed in each of said bores in said first surface and comprising a plurality of slots therein thereby allowing air in said first plenum chamber to enter said cooling zone; said second tray comprising a third surface contiguous to said drying zone and an opposed solid fourth surface contiguous to said cooling zone defining a second plenum chamber, a plurality of bores formed in said third surface, a disc member disposed in each of said bores in said third surface and comprising a plurality of slots therein allowing air in said second plenum chamber to enter said drying zone, a cooling air inlet means in operative association with said first plenum and a drying air inlet means in operative association with said second plenum.

8. Apparatus as recited in claim 7 further comprising cooling air exit means operatively connected to said cooling zone.

9. Apparatus as recited in claim 8 further comprising drying air exit means operatively connected to said drying zone.

10. Apparatus as recited in claim 9 wherein said first surface comprises an open area of greater than 0.8% of the total area of said first surface and said third surface comprises an open area of greater than 0.8% of the total area of said third surface.

11. Apparatus as recited in claim 10 wherein said first surface has an open area of between about 1.6% to about 2.4% and wherein said third surface has an open area of between about 1.6% to about 2.4%.

12. Process of drying and cooling meal comprising:
a) providing a drying zone for said meal and admitting air into said zone, said air being admitted to said drying zone from a first air plenum comprising a first surface adjacent said drying zone and an opposed second solid surface, said first surface comprising a plurality of bores therein with slotted discs disposed in said bores;
b) providing a cooling zone downstream from said drying zone and separated from said drying zone by said second solid surface of said first plenum, feeding cooled air having a temperature of from about ambient to about 5° C. above ambient into said cooling zone from a second air plenum having a third side adjacent said cooling zone and an opposed solid fourth side, said third side comprising a plurality of bores therein with slotted discs provided in said bores.

13. Process as recited in claim 12 wherein said first surface comprises an open area of greater than 0.8% of the total area of said first surface and said third surface comprises an open area of greater than 0.8% of the total area of said third surface.

14. Process as recited in claim 13 wherein said first surface has an open area of between about 1.6% to about 2.4% and wherein said third surface has an open area of between about 1.6 wt % to about 2.4 wt %.

15. Process as recited in claim 14 further comprising venting cooling air from said cooling zone and venting dry air from said drying zone.
